(19) United States
(12) Patent Application Publication
(10) Pub. No.: US 2026/0237911 A1
(43) Pub. Date: Aug. 13, 2026

(54) MICROWAVE RADIATION UNIT AND TRANSCEIVER THEREWITH

(71) Applicant: BEA SA, Angleur (BE)

(72) Inventors: Vincent KASCHTEN, Angleur (BE); Dimitri LEDERER, Court-Saint-Etienne (BE); Christophe CRAEYE, Mont-Saint-Guibert (BE); Alain Louis ZAMBON, Saint-Nicolas (BE)

(21) Appl. No.: 19/150,524

(22) PCT Filed: Jan. 26, 2024
(86) PCT No.: PCT/EP2024/051918

§ 371 Date: Jul. 23, 2025

(30) Foreign Application Priority Data
Jan. 27, 2023 (DE) 10 2023 102 086.2

(51) Int. Cl. H01Q 15/08; H01Q 3/34; H01Q 19/06

(52) U.S. Cl. CPC H01Q 15/08; H01Q 3/34; H01Q 19/062

(57) ABSTRACT

Microwave radiation unit comprises a refractive beamformer and at least one transmission line connected to the refractive beamformer by a transition structure. The at least one transition structure comprises a coupling structure and a waveguide having a main travel direction. The refractive beamformer and the waveguide each comprise parallel metallic layers and solid dielectric body between the parallel metallic layers. The solid dielectric body of the waveguide and the solid dielectric body of the beamformer comprise at least one common connecting layer of one solid dielectric material extending from the waveguide into the refractive beamformer so that the solid dielectric body of the waveguide and the solid dielectric body of the beamformer merge at least partially into each other. The at least one common connecting layer extends over the whole lateral extension of the solid dielectric body of the waveguide and the solid dielectric body of the beamformer.

The invention refers to a microwave radiation unit according to the preamble of claim 1.

It is known that a microwave radiation unit for transmitting and/or receiving microwave radiation comprises a refractive beamformer and at least one transmission line, where a transmission line is a structure capable of conducting electromagnetic waves.

The at least one transmission line is connected to the refractive beamformer by a transition structure, where the transition structure comprises a coupling structure and a waveguide. The coupling structure changes the orientation of the electric and magnetic fields of the electromagnetic wave conducted by the transmission line to a different orientation of the fields of the electromagnetic waves within the waveguide.

The waveguide defines a main travel direction for the electromagnetic waves, where the beamformer follows the waveguide in the main travel direction.

In a transmitting mode the electromagnetic microwave, which radiates from the coupling structure, is directed by the waveguide to travel in the main travel direction and then illuminates the refractive beamformer. The refractive beamformer emits a radiation shaped to a specific radiation pattern into air, where the radiation pattern depends on the refractive properties of the refractive beamformer. The refractive properties can be established by the choice of material or structural design.

Due to this quasi-optical behavior of the refractive beamformer, the so created radiation pattern is strictly related to the refractive properties of the refractive beamformer and the relative positioning of the waveguide thereto.

It is a problem of the prior art that the manufacturing of such an arrangement is rather difficult as the positioning of the waveguide relative to the refractive beamformer is critical to its behavior. As the refractive beamformer is a radiating part, the permittivity of the refractive beamformer is supposed to have a dielectric permittivity close to air. Accordingly, the edge region of the refractive beamformer could comprise a material of quite a low density which, however, does not provide for a robust implementation of such a refractive beamformer.

US 2014/0176377 A1 discloses an antenna system having a cylindrical lens which focuses electromagnetic waves. The lens is connected by a waveguide which is integrated into metallic layers covering the cylindrical lens on opposite sides. A coupling structure or substrate integrated waveguides can be placed inside trenches of the lens. The precision of positioning is related to mechanical tolerances.

Numan, A. B., Frigon, J. F., Laurin, J. J., Printed W-band multibeam antenna with Luneburg lens-based beamforming network, IEEE Transactions on Antennas and Propag, 2018, 66 10, 5614-5619, shows a refractive beamformer where the beamformer as well as the adjacent waveguide are of a solid dielectric body, in particular a body of PCB (printed circuit board) layer. The waveguide is embodied as a substrate-integrated waveguide whose material merges into the material of the refractive beamformer. Furthermore, the solid dielectric body of the beamformer is constituted of two different materials. A dielectric disc comprising a first inner material of a higher permittivity is embedded at the lens center and is surrounded by a peripheral region comprising an outer material of a lower permittivity. The solid dielectric body comprises through-holes that are distributed over the lateral extension of the solid dielectric body to impact the density of the solid dielectric body and thereby achieve a graded index lens. The permittivity in the outer edge zone of the disc matches the permittivity of the inner edge zone of the peripheral region. The permittivity of the peripheral region further decreases towards its outer edge zone. The graded index is distributed in a way to constitute a matched Luneburg lens, as the medium surrounding the lens and the permittivity at the edge zone of the lens are matched to one another. The radiation of the electromagnetic wave to air is achieved via antennas connected to the Luneburg lens. According to this disclosure two different solid dielectric materials are needed to provide the necessary range of permittivity from the center of 3.66 to the edge of 2.16.

Accordingly, by using a solid dielectric body between to metallic layers, in particular a dielectric layer of a PCB core, a microwave radiation unit is provided.

It is an object of the invention to use the principle of a refractive beamformer and allow a reliable and easier manufacturing process and to be able to use the microwave radiation unit at a microwave frequency above 50 GHz.

The object is solved by the characterizing features of claim 1 together with the features of its preamble.

The subclaims are further advantageous embodiments of the invention.

The invention is based on the knowledge that a relative edge permittivity of a refractive beamformer, well above 1, is acceptable under some conditions, so that the refractive beamformer emits a radiation shaped to a specific radiation pattern into air.

In a known manner, a microwave radiation unit for transmitting and/or receiving microwave radiation comprises a refractive beamformer and at least one transmission line, where the transmission line is a structure capable of conducting electromagnetic waves.

The at least one transmission line is connected to the refractive beamformer by a transition structure, where the transition structure comprises a coupling structure and a waveguide. The coupling structure changes the orientation of the electromagnetic wave, as conducted by the transmission line, to a different orientation of the electromagnetic wave within the waveguide.

The waveguide is embodied in a way that it defines a main travel direction, where the beamformer is adjacent to the waveguide in the main travel direction.

The refractive beamformer, as well as the waveguide, each comprise parallel metallic layers and a solid dielectric body between them. Accordingly, the parallel metallic layers confine the respective solid dielectric body on two opposite sides, namely the top side and the bottom side. The parallel metallic layers create a main travel direction for the microwaves which is basically parallel to the top side and the bottom side metallic layers. A solid dielectric body comprises at least a structure of a solid dielectric material, in particular it may be a body of full material into which holes are inserted.

Furthermore, in a known way, the solid dielectric body of the waveguide comprises a waveguide connection zone whereas the solid dielectric body of the refractive beamformer comprises a beamformer connection zone. An electromagnetic wave propagates from the beamformer connection zone to the waveguide connection zone or the other way around. The waveguide connection zone and the beamformer connection zone both extend in the main travel direction and transverse thereto.

The solid dielectric body of the waveguide and the solid dielectric body of the refractive beamformer comprise at least one common connecting layer made of one solid dielectric material extending from the waveguide into the refractive beamformer.

According to the invention the at least one common connecting layer extends over the whole lateral extension of the solid dielectric body of the waveguide and the solid dielectric body of the beamformer.

According to the invention the at least one connecting layer of the waveguide and the solid dielectric body of the refractive beamformer is made of the same solid dielectric material.

Consequently, the transition is facilitated in a way that the at least one common connecting layer made of solid dielectric material connects the refractive beamformer and the waveguide. Accordingly, at least in the direction of the length extension of the waveguide a materially uniform transition is provided.

Accordingly, the common connecting layer in the main travel direction and transverse thereto, is set to encompass the adjacent waveguide connection zone and the beamformer connection zone in the respective directions, so that the solid dielectric body of the waveguide and the solid dielectric body of the refractive beamformer merge, at least partially, into each other.

Particularly, the waveguide connection zone may have a depth of at least 20 micrometers from the functional boundary of the waveguide in the main travel direction and/or the beamformer connection zone may have a depth of at least 20 micrometers from the functional boundary of the beamformer in the main travel direction.

As the electromagnetic wave transitions between the waveguide and the refractive beamformer in one solid dielectric material, a continuous transition is provided and potential reflections at the interface between the refractive beamformer and the waveguide are reduced. Above this, as the refractive beamformer and the waveguide are solidly interconnected, a strong mechanical connection is achieved therebetween and a very accurate positioning between the refractive beamformer and the waveguide is provided.

The one dielectric material can be a composite material, particularly a monolithic composite material, in particular comprising a fiber and a resin.

According to an advantageous embodiment, the common connecting layer comprises an interconnecting region which extends between the refractive beamformer and the waveguide. The interconnecting region may extend between the functional boundary of the waveguide and the functional boundary of the refractive beamformer. The interconnecting region is a continuous material connection being a transition region extending from the waveguide to the beamformer. It is also possible that the waveguide connection zone and the beamformer connection zone overlap so that there is no interconnecting region.

According to a preferred embodiment, the extension of the common connecting layer in a direction orthogonal to the metallic layers corresponds to the distance between the parallel metallic layers. This provides a homogenous transition over the whole height of the waveguide. Alternatively, the solid dielectric body of the waveguide and the solid dielectric body of the refractive beamformer comprise a plurality of common connecting layers, which are preferably made of different materials having a similar permittivity. Such a setup may be produced more easily.

In particular, the at least one common connecting layer extends over the whole lateral extension of the dielectric body of the waveguide and/or the dielectric body of the beamformer.

According to a preferable embodiment of the invention, the solid dielectric body of the waveguide, in which the electromagnetic microwave travels, comprises at least one layer of a solid dielectric material having a high relative dielectric permittivity of more than 2.5, preferably more than 3, particularly 3.66.

In particular, the at least one layer of one dielectric material of the solid dielectric body of the refractive beamformer has a high relative dielectric permittivity of about 3, more particular of about 3.66.

According to the high relative dielectric permittivity of the solid dielectric body, the dimensions of the waveguide can be reduced while maintaining a certain frequency of operation. This allows for a plurality of transition structures to be used on a common refractive beamformer having a certain size. A good coupling is achieved between the solid dielectric body of the waveguide and the solid dielectric body of the refractive beamformer because the reflection between waveguide and refractive beamformer is reduced as a result of the at least one common connecting layer made of one material merging the two functional elements, although the edge permittivity of the refractive beamformer is higher than that of air.

Accordingly, a microwave radiation unit is created comprising a mechanically strong interconnection between the waveguide and the refractive beamformer and having a high radiation efficiency.

According to a preferable embodiment of the invention, the dielectric permittivity of the material of the respective solid dielectric bodies of the connection zones of the refractive beamformer and the waveguide are set to match the dielectric permittivity of the material of the solid dielectric body of the waveguide so that the reflection at this transition from one solid dielectric material to another having an equal permittivity is kept low. As a result, a very good coupling from the lens to the waveguide is achieved and losses are reduced. Accordingly, radiation efficiency is improved so that power consumption can be reduced.

It was found that the mismatched transition from the refractive beamformer to air can be largely compensated by the appropriate design of the refractive beamformer. By choosing appropriate refractive properties, the intended shape of the beam can be achieved despite this mismatched transition.

Particularly, the refractive beamformer is of a shape having a circular or elliptical cross-section. Due to the choice of the cross-sectional shape of the beamformer, the radiation pattern can be further adapted to account for on-site geometrical configuration.

According to a most preferable embodiment the refractive beamformer is set directly adjacent to the waveguide, so that there is no distance between the very end of the waveguide and the beginning of the refractive beamformer. According to this setup the coupling position of the waveguide is established in a very precise way.

The waveguide preferably has a rectangular cross-section and comprises side walls that are perpendicular to the metallic layer on the top side and the bottom side of the waveguide. Along the main travel direction, the waveguide ends at the very end of the side walls of the waveguide that are perpendicular to the metallic layer on the top side and the bottom side of the waveguide. In case the sidewalls are embodied as vias the waveguide terminates at the last via in the main travel direction.

According to a very preferred embodiment, the refractive beamformer is a gradient index lens, particularly a generalized Luneburg lens. In this embodiment, the beamformer can shape a radiation entering the refractive beamformer from the waveguide to a fan shaped beam, for instance. In case of a radiation pattern comprising a fan shaped beam, the permittivity could, for example, be higher in the center of the lens than at its edge. This change in permittivity can be achieved by varying the density of the solid dielectric body by removing solid dielectric material from the solid dielectric body Consequently, the maximum permittivity that can be achieved is given by the permittivity of the solid dielectric material itself. In case of a generalized Luneburg lens, in particular, the density of the solid dielectric body of the beamformer decreases in its density from the center to the edge.

Preferably, the solid dielectric material is chosen to meet the conditions with respect to the size of the waveguide. The maximum permittivity can preferably be produced in the center of the lens having approximately the permittivity of the waveguide. Furthermore, the edge permittivity of the lens can be reduced by removing or gradually reducing the material towards the edge region.

In this case, as the solid dielectric material cannot be completely absent at the edge, a solid dielectric material remains so that the at least one common connecting layer of one material can extend from the waveguide to the lens/beamformer. Although the permittivity of the solid dielectric body as a whole, as it is perceived by the electromagnetic wave, is mismatched, the permittivity of the solid dielectric material itself is matched and hence the reflection of the electromagnetic wave is reduced at the adjacent connection zones and the radiation efficiency is increased.

The solid dielectric material can be a material compound, particularly composite material.

Luneburg lenses are well known in the prior art and comprise defined radiation properties that are strictly dependent on the positioning of the waveguide relative to the circumference of the beamformer, and particularly allow a fan shaped beam that can beneficially be used for radar imaging applications.

According to a preferred aspect of the invention, the solid dielectric material of the common connecting layer extends over a significant part of the waveguide and is hence chosen to have a higher permittivity than air to reduce the dimensions of the waveguide at a given frequency. This, however, leads to the effect that the permittivity (epsilon) at the edge of such a lens is increased with respect to a classical Luneburg lens and is, therefore, mismatched with respect to the permittivity of air.

As the effect of the mismatched transition is compensated by the design of the lens, it does not significantly affect the radiation properties, but allows a good transition between waveguide and lens.

According to a further preferred embodiment the refractive beamformer, more particularly the lens, is of a cylindrical shape, having a middle axis. Especially in this case, the lens' epsilon (permittivity) at the center around the middle axis is set according to a design rule so that the lens focuses the electromagnetic energy similar to the classical Luneburg lens, although comprising an offset edge permittivity to the classical Luneburg lens.

As the permittivity of the waveguide's solid dielectric material equals the permittivity of the solid dielectric material at the beamformer's edge, in particular, the lens's edge, the focusing properties of the lens can be ensured, even though the dielectric permittivity at the lens's edge is greater than that of air, when the epsilon in the lens center and the lens edge are adapted according to a specific lens design rule.

According to this particular design rule, the relation between the center relative dielectric permittivity ε_{centre} and the edge relative dielectric permittivity ε_{peripheral edge} preferably follows the relation: ε_{centre}=1.42 √ε_{peripheral edge}+0.58 with a tolerance band of 0.2. According to this design rule, in some cases the edge permittivity is smaller at the center than at the edge, while in other cases it is the opposite. According to the particular design rule the deviation of permittivity from the center to the edge can be chosen small enough such that the necessary variation can be achieved with one solid dielectric material by varying the density of the solid dielectric body of the beamformer.

Accordingly, the focusing properties of a classical Luneburg lens can almost be achieved with an epsilon edge >1.5.

According to a very preferred embodiment the refractive beamformer is of the same height as the waveguide, especially the distance of the respective opposite metallic layers is equal, particularly about 2.2 mm. In case of a cylindrical lens, the height is the dimension along the middle axis. The height of the lens is the extension perpendicular to the circular faces of the lens. The larger the height the smaller the second dimension of the fan shaped beam.

The parallel metallic layers of the waveguide and the parallel metallic layers of the lens can be interconnected. According to such an embodiment the waveguide and the refractive beamformer, more particularly the cylindrical lens, can be manufactured as a single flat piece of solid dielectric material covered by a pair of metallic single layers on opposite sides of the solid dielectric material.

The lens, particularly the cylindrical lens, is preferably made of a single solid dielectric material, where the refractive properties of the lens are influenced by holes introduced into this solid dielectric body. Particularly, the holes are filled with air. The holes are introduced in a way to change the density of the lens by changing quantity or diameter of the holes in a way that the lens density varies from the edge region to the center, in particular increases. The holes are introduced preferably parallel to the middle axis and extend through the whole thickness of the lens.

Preferably, the waveguide is a rectangular waveguide, where the height of the lens equals the height of the waveguide and where the width of the waveguide is set to work at a given frequency band.

The length of the waveguide in main travel direction corresponds to a manifold of half the guided wavelength L_{G}. The guided wavelength is defined as the minimum distance between two equal phase planes along the waveguide. L_{G}=L/(sqrt(1−(f_{c}/f)²)), where f_{c}=is the cutoff frequency, f is the (central) frequency of operation and L is the wavelength in a certain dielectric medium corresponding to the frequency f.

The cutoff frequency is set by the waveguide dimensions: f_{c}=c/2a, where a is the width of the waveguide, in case of vertical polarization, or f_{c}=c/2b, where b is the height of the waveguide, particularly the height of the lens, in case of horizontal polarization.

The height of the waveguide is h>lambda_{considering the DSM of the waveguide}/2, where lambda_{considering the DSM of the waveguide} is the same as the guided wavelength L_{G}, where the respective dielectric medium is the solid dielectric material of the wave guide; for a polarization where the E-Field is perpendicular to the middle axis of the cylindrical lens, achievable by a probe extending perpendicular to the lens axis into the waveguide.

The width of the waveguide, being the dimension perpendicular to the height axis of the lens, is preferably w>lambda_{considering the DSM of the waveguide}/2; for a polarization parallel to the middle axis of the cylindrical lens, achievable by a probe extending parallel to the lens axis into the waveguide.

Accordingly, the transmission line can be a coaxial cable and the coupling structure can be the inner wire of a coaxial cable extending into a hole, particularly a blind hole of the solid dielectric body of the waveguide, where the inner wire penetrates a wall of the waveguide without being in electrical contact with it.

According to the invention, in the case of the probe extending parallel to the middle axis, the width of the waveguide is smaller than the height of the waveguide, while both the width and the height of the waveguide are larger than half a wavelength, namely a wavelength considering the solid dielectric material of the waveguide. In this case the probe excites a propagation mode in which it features the second lowest cutoff frequency, namely TE₁₀, according to waveguide standard notation referring to (TEₘₙ) where m is an index referring to the width and n refers to the height of the waveguide.

According to the invention, the waveguide is filled with a solid dielectric material having a higher relative permittivity than air, therefore the wavelength in the solid dielectric material is smaller than in air, and thus the width of the waveguide can be reduced relative to the lens diameter. The lens diameter is given by the diameter of the parallel metallic layers.

The reduced width of the waveguides effectuates a higher resolution of adjacent waveguides, particularly along the circumference of a cylindrical lens.

According to a further advantageous embodiment of the invention the transmission line, the transmission structure and the refractive beamformer are integrally manufactured in a single piece. This means that the dielectric body of the transmission line, the dielectric body of the waveguide and the dielectric body of the lens comprise at least one common connecting layer of the same dielectric material.

In this case, the coupling structure particularly comprises a probe. Although the probe can lie perpendicular to the middle axis of the lens, it preferably extends parallel to the middle axis of the lens.

In the case of the probe extending parallel to the middle axis, the length of the probe within the waveguide is particularly half of the height of the waveguide. The diameter of the probe is small compared to the guided wavelength L_{G}, ideally as small as possible.

Preferably, the solid dielectric material of the waveguide and of the lens and the metallic layers are part of a multilayer printed circuit board structure (PCB-structure) that comprises layers being prepreg layers and/or core layers, where core layers comprise metallic layer(s) as well as dielectric layer(s). The core layer(s) and prepreg layers are stacked along the direction of the middle axis, where the layers each comprise a dielectric layer of one solid dielectric material that extends integrally from the waveguide to the lens. The solid dielectric body in this case comprises a plurality of composite material layers. Such a solid dielectric material layer, particularly of a core or a prepreg layer, may comprise a fiber fabric, particularly a woven glass fiber fabric and a polymer matrix, particularly resin. As one solid dielectric material extends from the waveguide to the lens, there is a monolithic transition from the waveguide to the refractive beamformer, namely the lens, along the main propagation direction. Using a plurality of layers of composite material allows for a thin and mechanically robust device. Preferably, the permittivity of the layers is matched so that the solid dielectric material of each layer comprises a similar permittivity. In the case of multiple core layers being used in between the outermost metal layers, the intermediate metal layers of the core layers are removed in the lens region and in the waveguide region, where a solid dielectric body is required. The metal coating is removed before the separate layers are assembled.

In a preferred embodiment, the relative permittivity of all the dielectric material of the layers lies within a range of 3.4 and 3.8. Accordingly, the permittivity is not only kept constant along the main travel direction, but it is also kept within a narrow range in height direction. Although the permittivity of the solid dielectric material is in said range, the solid dielectric body, in particular due to holes, has a permittivity of 2.6 in the edge zone and of about 2.9 in the center of the beamformer, where the solid dielectric body of the waveguide preferably has a permittivity of between 3.4 and 3.8.

Particularly, the transmission line and the coupling structure are embodied as a PCB-structure as well. In this case the coupling structure being a probe which extends parallel to the lens axis is manufactured as a metalized blind via.

The multilayer circuit board then comprises a middle core layer having at least one metallic layer, where the blind via connects said metallic layer to the transmission line which preferably comprises a first metalized conducting path that is particularly positioned on the top layer of the solid dielectric body. The trace of the conducting path is not connected to the metalized top layer covering the dielectric material of the waveguide. Said metallic layer of the middle core layer, where a middle core layer could be one of a plurality of middle core layers between the parallel metallic layers, preferably has as equal a distance as possible to the outermost parallel metallic layers.

The conducting path of the transmission line may also comprise a second trace being placed in parallel to the first conducting path, distant in the extension along the middle axis of the lens, where the first and the second conducting path are separated by a layer of solid dielectric material. The conducting path can be established by using the metal layers on both sides of the solid dielectric layer of a core layer.

The second trace preferably is a ground layer of the PCB structure. With this topology a G-CPW transmission can be generated. In comparison to the first conducting path, the second trace does not contact the blind via but may extend semi-circularly around it. It may even fully encircle the blind via but does not extend significantly beyond the blind via into the waveguide in the main travel direction.

The sidewalls of the waveguide are particularly embodied as through vias, where the through vias of the same wall have an adjacent distance that is small compared to the guided wavelength. The distance is smaller than the lambda/2 in the solid dielectric body. According to the invention the distance between the middle axis of vias in the main travel direction of the wave is smaller than 0.8 mm, preferably less than 0.5 mm.

In the case of embodying the radiation unit as a PCB structure, the solid dielectric body of the lens comprises multiple layers of solid dielectric material where the density of the lens is influenced by the distribution of through holes. The through holes, which can be of any cross-sectional shape, are introduced after all layers have been assembled. The through holes can be laser drilled to allow for a high precision, which is especially useful in specific regions where a high number of holes is needed to allow for a low permittivity. Preferably, the through holes have a circular cross-section, as it is easy to manufacture.

According to a very preferred embodiment the microwave radiation unit comprises a lens and a plurality of transmission lines and waveguides as previously described.

A further aspect of the invention refers to a printed circuit board transceiver comprising at least one radiation unit according as previously described. At least one transmission line is connected to at least one integrated circuit to feed and/or receive signals from the radiation unit, where the integrated circuit is mounted on the same multilayer circuit board as the radiation unit.

According to such an embodiment the losses of the radiation unit are low.

The integrated circuit is preferably mounted on a layer of the PCB-structure where the transmission line is accessible, more preferably on the top or the bottom layer.

According to this setup high power efficiency is provided and disturbances are reduced.

According to a further preferable embodiment of the printed circuit board transceiver it comprises two pre-described microwave radiation units, where both microwave radiation units are connected to the at least one integrated circuit, where at least one integrated circuit particularly is a radar circuit.

This allows a high-resolution radar application, at a high frequency, in particular at a frequency range around 60 GHz.

According to a further improvement of the invention, the printed circuit board transceiver comprises a circuit board with a first rigid part having a first microwave radiation unit and having a second rigid part with a second microwave radiation unit and a connecting part, where the first part and the second part are interconnected by a connecting part in a way that the first part is inclinable relative to the second part. Preferably, the connecting part is embodied in such a way that the first part and the second part and the connecting part comprise a mutual layer, where the thickness of the connecting part is less than that of the first and the second parts, so that the connecting part is flexible, particularly bendable, so that the first part is inclinable relative to the second part in the sense of a film hinge.

Both the lens and waveguide are part of the same structural element that is a stack of layers, where each dielectric layer can be of a monolithic solid dielectric material. The stack of layers consists of core layers and prepreg layers, where the prepreg layers are chosen for high frequency application and with a dielectric permittivity close to that of the dielectric material of the core. The stacked layers are a laminated sandwich structure, like a printed circuit board, or the structural element is a printed circuit board.

Further improvements of the invention are described in the figures. The figures show:

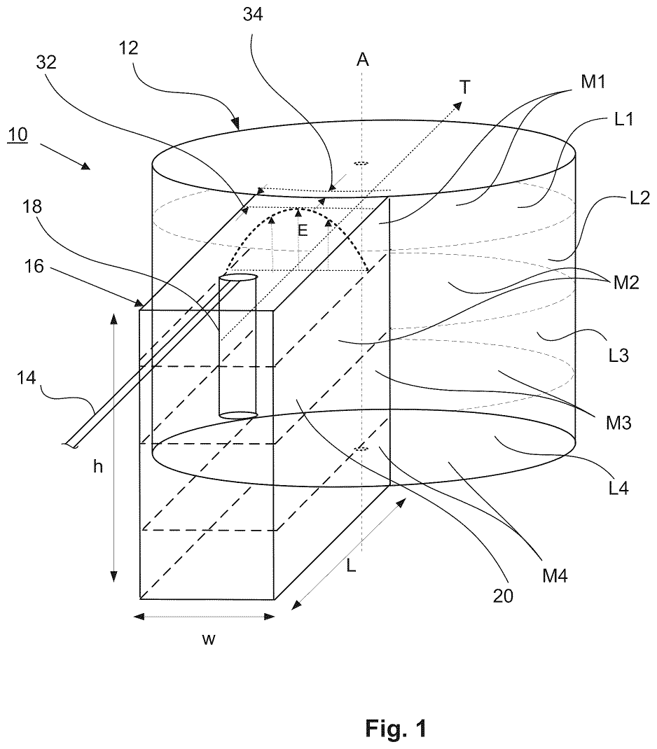

FIG. 1 an isometric view of a basic principle of a microwave radiation unit;

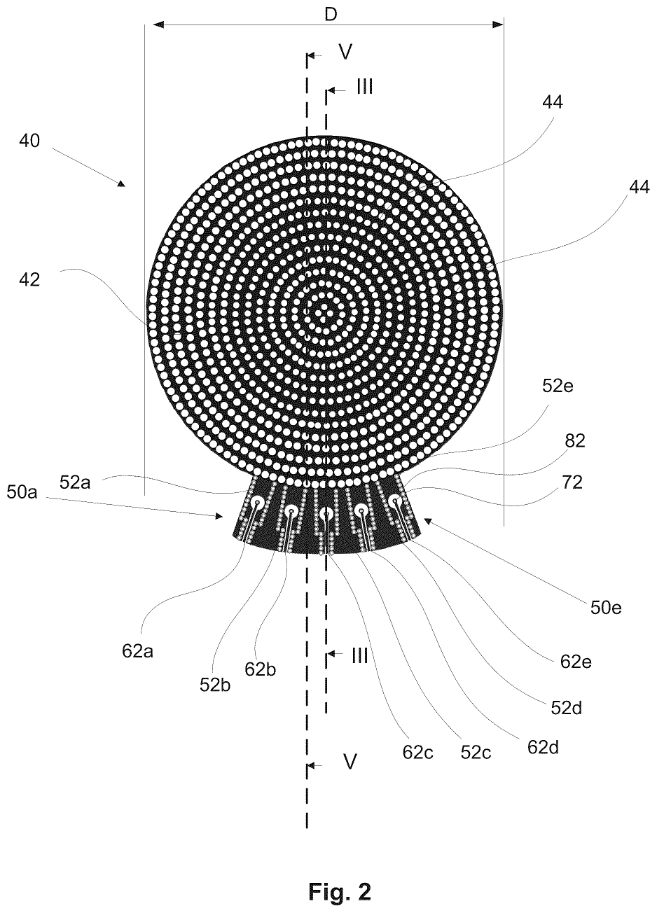

FIG. 2 a top view of a microwave radiation unit;

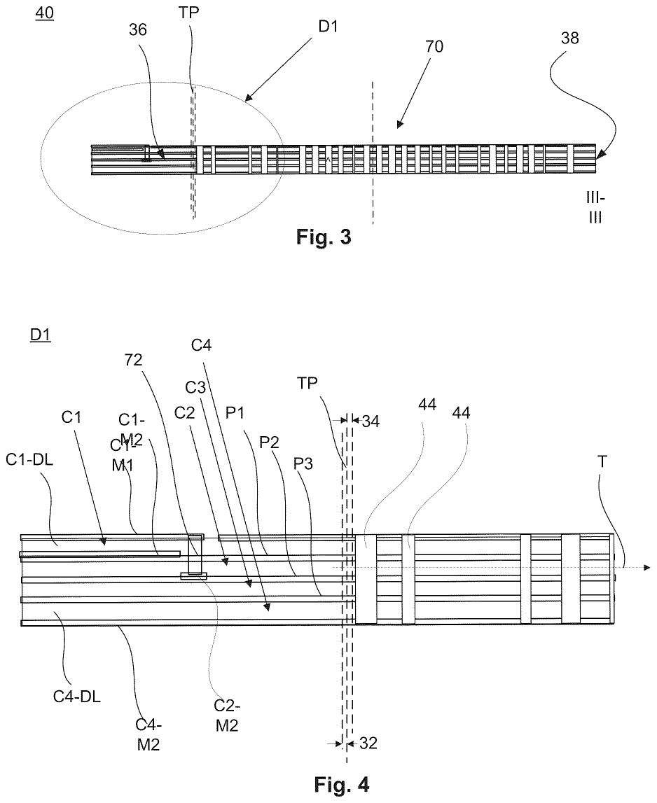

FIG. 3 a cross-sectional view III-III of FIG. 2;

FIG. 4 a detailed view of the cross-section of FIG. 3;

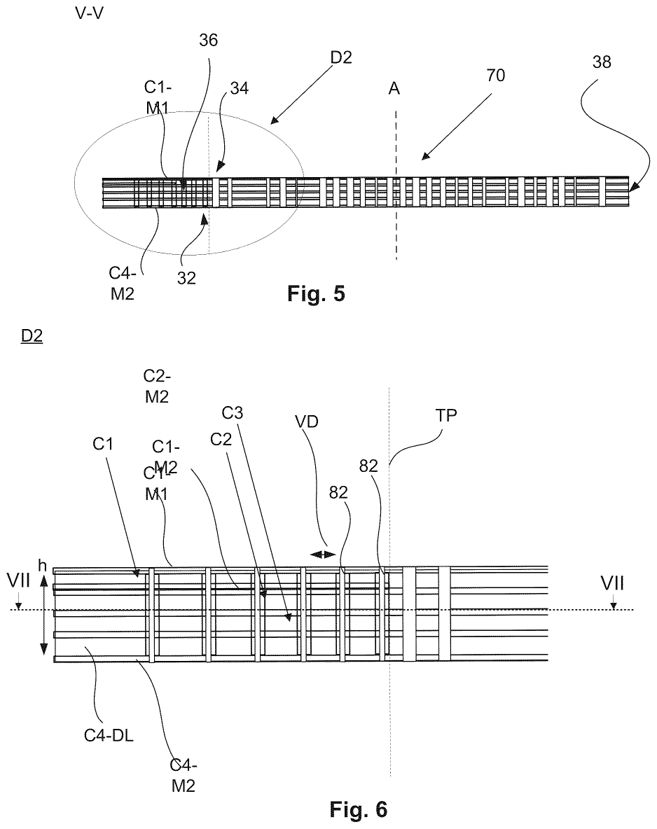

FIG. 5 a cross-sectional view of V-V of FIG. 2;

FIG. 6 a detailed view of FIG. 5;

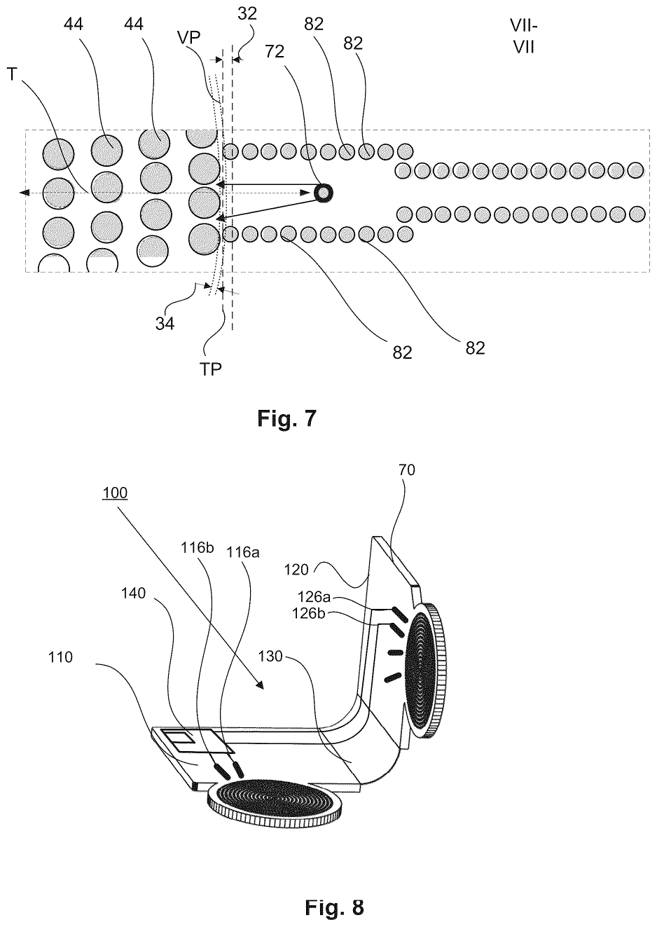

FIG. 7 a detailed DP perspective cut view of FIG. 2, and

FIG. 8 a radar device comprising two radiation units.

FIG. 1 shows a microwave radiation unit 10 in a setup being a basic principle in a perspective view.

It shall be noted, that in this embodiment only one waveguide and one transition structure is exemplarily shown, however a plurality of waveguides and transition structures can be assembled, together with the refractive beamformer in an analogous way.

The microwave radiation unit 10 comprises a refractive beamformer 12 and at least one transmission line 14. The at least one transmission line 14 is connected to the refractive beamformer 12 by a transition structure 16, where the transition structure 16 comprises a coupling structure 18 and a waveguide 20 having a main travel direction T in which the electromagnetic microwave travels. Along the main travel direction T the microwave travels from the coupling structure 18 towards the refractive beamformer 12.

The refractive beamformer 12 and the waveguide 20 each comprise a solid dielectric body. According to the invention, the dielectric body of the refractive beamformer and the dielectric body of the waveguide comprise at least one common connecting layer L1, L2, L3, L4 which is made of a solid dielectric material M1, M2, M3, M4 respectively. The common connecting layers L2, L3, L4 can be arranged analogously to the common connecting layer L1 which is discussed in detail in FIG. 1 exemplarily.

In FIG. 1, the common connecting layer L1 is common to both the solid dielectric body of the waveguide and the solid dielectric body of the refractive beamformer. The common connecting layer L1 is made of one dielectric material M1 which extends from the waveguide 20 to the refractive beamformer 12 in the main travel direction T of the wave, thereby connecting the waveguide 20 with the refractive beamformer 12. Accordingly, e.g., within the uppermost layer L1, the microwave travels inside the same solid dielectric material from the waveguide 20 into the refractive beamformer 12. In this example, the at least one common connecting layer L1 extends over the whole dielectric body of the waveguide 20 and the whole dielectric body of the refractive beamformer 12 in the lateral extension.

Furthermore, a waveguide connection zone 32 is shown which extends from the very end of the waveguide 20 in the direction of the probe over a certain distance. The shown position at the end of the waveguide 20 is the functional boundary of the waveguide 20. The extension of the waveguide connection zone 32 is less than 2 mm, down to 20 micrometers.

Furthermore, the beamformer connection zone 34 is shown, which extends from the edge of the beamformer 12 towards its center. The extension of the beamformer connection zone 34 is less than 2 mm, down to 20 micrometers. In the shown example, the waveguide connection zone 32 and the beamformer connection zone 34 overlap. The common connecting layer L1, according to the invention, fully extends over the waveguide connection zone 32 and the beamformer connection zone 34. The common connecting layer L1 extends from the end of the waveguide connection zone 32 to the end of the beamformer connection zone 34.

In this example, each of the four layers L1, L2, L3, L4 extends from the waveguide 20 to the refractive beamformer 12 comprising one dielectric material. Basically, the permittivity of each solid dielectric material M1, M2, M3, M4 is almost the same so that the whole dielectric substrate has the same permittivity throughout. Alternatively, the substrate does not necessarily need to be built up in layers of one solid dielectric material but could also be a solid dielectric body of a single material. In this example each layer L1, L2, L3, L4 is a common connecting layer that extends from the waveguide 20 to the refractive beamformer 12.

According to this smooth transition from the waveguide 20 to the refractive beamformer 12, reflections that would reduce the efficiency, can be avoided at the transition between the waveguide 20 and the beamformer 12.

The refractive beamformer 12 shapes the electromagnetic wave and radiates it into the surrounding air.

Furthermore, the radiation unit comprises metallic layers on opposite sides of the solid dielectric material, namely at a top side above the solid dielectric material of the uppermost layer L1 and below the lowermost layer L4. The metallic layers confine the refractive beamformer 12 as well as the at least one waveguide 20. For the sake of clarity, the metallic layers are omitted in this figure.

The waveguide 20 is a rectangular waveguide where the particular implementation is described by the subsequent figures. The rectangular waveguide 20 has a width w and a height h, where the height is parallel to the middle axis A of the cylindrically shaped refractive beamformer 12.

The coupling unit 18 is a probe which extends parallel to the middle axis A of the cylindrical refractive beamformer 12.

In this setup a wave is generated in the TE₁₀ mode, where the E-Field, and hence the polarization of the microwave, is parallel to the middle axis A.

FIG. 2 shows a top view of a microwave radiation unit 40 having a refractive beamformer being a cylindrical lens 42, and five transition structures 50a, 50b, 50c, 50d, 50e each comprising a waveguide 52a, 52b, 52c, 52d, 52e respectively. The lens 42 is a cylindrical lens having a plurality of holes 44 to influence the permittivity of the lens 42. All waveguides 52a, 52b, 52c, 52d, 52e are connected to the same refractive beamformer 42. The transition structures 50a, 50b, 50c, 50d, 50e are connected to a circuit via their respective transmission lines 62a, 62b, 62c, 62d, 62e. The traces of the transmission lines 62a, 62b, 62c, 62d, 62e are etched out from a full metallic layer. The metallic material is shown in black.

Due to the relatively high relative permittivity of the dielectric body of the waveguide 52a, 52b, 52c, 52d, 52e, the dimensions of the waveguide 52a, 52b, 52c, 52d, 52e can be rather small in width so that they can be put closely together so that they can potentially generate intermediate beams.

The metal layer of the lens 42 has a diameter D that is the relevant diameter for the lens calculations. The solid dielectric body between the parallel metallic layers can preferably have the same diameter D or a slightly bigger one. A slightly bigger diameter of the solid dielectric body might be necessary as in PCB-manufacturing techniques the printed circuit board can only be cut after lamination of the layers. As it has to be ensured that the metal layer has a very precise perimeter, the cutting of the lens has to be made with some safety distance.

The through holes 44 impact the permittivity of the dielectric body, where the holes 44 have the smallest distance to the perimeter, which is preferably less than 100 μm. The through holes 44 in the present embodiment have a circular cross-sectional shape but they also could have any other shape.

The size of the holes 44 varies in a way that they have a bigger diameter closer to the perimeter and a smaller diameter closer to the middle of the lens 42. Preferably the holes 44 are arranged in an azimuthal symmetry.

Nevertheless, alternative solutions are thinkable, which have an asymmetry with respect to the lateral distribution. It is possible that the shape and the distribution of the holes 44 vary more or less randomly, but, nevertheless, this variation realizes a specific gradient of the relative permittivity to provide a gradient refractive index preferably evolving with the radial distance as a square law.

The waveguide 52a, 52b, 52c, 52d, 52e ends in close proximity to the virtual perimeter of the lens 42. The distance between the waveguide 52a, 52b, 52c, 52d, 52e and the virtual perimeter of the lens 42 is preferably less than the distance of the diameter of a via. The virtual perimeter e.g., is defined by the diameter of the metallic layer of the lens 42. In a very preferred way, the distance from the center of the lens 42 to its focal point is bigger than the distance to the end of the waveguide 52a, 52b, 52c, 52d, 52e that lies outside the perimeter of the holes 44 but inside the perimeter of the metal layer.

The shown lens 42 generates a radiation pattern comprising a fan shaped beam.

In this example, there are five transition structures 50a, 50b, 50c, 50d, 50e, where the relative permittivity εᵣ of the solid dielectric body is above 2.5 more preferably above 3. Due to the rather high permittivity, the size of the waveguides 52a, 52b, 52c, 52d, 52e can be reduced at a certain frequency. Accordingly, a plurality of transition structures 50a, 50b, 50c, 50d, 50e can be provided to increase the resolution achievable with a single refractive beamformer for a given frequency.

FIG. 3 shows a cross-sectional view along the cutting line III-III of FIG. 2. The cross-sectional view shows an exemplary embodiment of a stacked microwave radiation unit 40 according to the invention. The transition from the dielectric body 36 of the waveguide to the dielectric body 38 of the lens 42 at the transition point TP shows that each of the layers comprises one dielectric material that extends uniformly from the waveguide 52c into the lens 42. The microwave radiation unit 40 is embodied as a printed circuit board having a plurality of layers. The layers are described in more detail by the detailed view of D1 as shown in FIG. 4.

FIG. 4 shows a detailed view of the detail D1 of FIG. 3. The stack comprises four core layers C1, C2, C3, C4 that are interconnected by three prepreg layers P1, P2, P3 being of a dielectric material. The uppermost core layer C1 comprises a metal layer C1-M1, preferably copper, at its upper side extending over the waveguides 52a, 52b, 52c, 52d, 52e and the lens 42. The lowermost core C4 comprises a metal layer C4-M2 at its lower side also extending over the waveguides 52a, 52b, 52c, 52d, 52e and the lens 42. The metal layers C1-M1 and C4-M2 confine the microwave in an axial direction parallel to the middle axis A.

The metal layer C1-M1 is interrupted beyond the coupling structure 72 as the metal layer C1-M1 forms a trace of the transmission line 62c in its first part until it reaches the coupling structure 72. The second trace of the transmission line 62c in this part is established by the lower metal layer C1-M2. In this case the metal layer C1-M2 does not extend beyond the coupling structure 72. The coupling structure 72 may be connected to the lower metal layer C2-M2 of the second core layer C2. The coupling structure 72 is constructed as a blind via that can be filled with metal. As can be seen in this cross-section the intermediate metal layers of the core layers C1 to C4 have been broadly removed so that the remaining substrate basically consists of the dielectric parts C1-DL, C2-DL, C3-DL, C4-DL and the interconnecting solid dielectric material of the prepreg layers P1, P2, P3. The permittivity of the dielectric material of the prepreg layers P1, P2, P3 and the dielectric core layers C1-DL, C2-DL, C3-DL, C4-DL is closely matched to provide rather uniform properties not only in the travel direction T but also in the height direction.

As the dielectric material within the waveguide has a high relative dielectric permittivity (>3) the height h and especially the width w of the waveguide can be reduced relative to a waveguide being filled with air.

As can be seen, the holes 44 are through holes simply drilled through the whole height of the stack.

The metal layers C1-M1 and C1-M2 forming the transmission line 62c can be used over the whole device to provide the connecting transmission lines 62a, 62b, 62c, 62d, 62e.

FIG. 5 shows a cross-sectional view along the cutting line V-V of FIG. 2. This shows a cross-section through the sidewall of the rectangular waveguide 52b. The layers C1-M1 and C4-M2 implement the upper and the lower wall of the rectangular waveguide 52b.

Furthermore, the waveguide connection zone 32 is shown which extends from the very end of the waveguide 52b in the direction of the probe over a certain distance. The shown position at the end of the waveguide 52b is the functional boundary of the waveguide 52b. The extension of the waveguide connection zone 32 is less than 2 mm, down to 20 micrometers.

Furthermore, the beamformer connection zone 34 is shown which extends from the edge of the beamformer to its center. The extension of the beamformer connection zone 34 is less than 2 mm, down to 20 micrometers.

According to the invention, the beamformer 42 and the waveguide 52b share a common connecting layer of a dielectric material extending at least so far as to cover the beamformer connection zone 34 and the waveguide connection zone 32.

FIG. 6 shows a more detailed view D2 of FIG. 5 with through vias 82 stretching from the top metal layer C1-M1 to the bottom metal layer C4-M2. Accordingly, this distance between the metal layers C1-M1, C4-M2 gives the height h of the waveguide 52c. The distance VD between two vias 82 is set to be small relative to the wavelength the microwave has in the dielectric material.

FIG. 7 shows a perspective cross-sectional view at the cutting line VII-VII of FIG. 6 at the transition. The connection zone extends from the end of the waveguide connection zone 32 closest to the probe to the end of the beamformer connection zone 34 closest to the center of the refractive beamformer. It can be understood that along the main travel direction T of the waveguide 52b the solid dielectric material extends from the waveguide 52b to the lens 42 extending over the connection zone.

As the permittivity of the solid dielectric material is equal at the transition point TP there is no reflection. Then in the transition zone there is equivalent permittivity. The permittivity of the solid dielectric body of the refractive beamformer 42 changes within the virtual perimeter VP of the lens and refraction takes place.

The vias 82 of the waveguide 52b as well as the vias 44 of the lens can be manufactured very precisely. Accordingly, a very accurately positioned transition point between waveguide and lens can be manufactured that comprises a robust mechanical behavior and still has a rather small size. As can be seen, although the overall dielectric permittivity of the lens and that of the waveguide is different due to the holes 44 introduced into the PCB, the reflective properties are nonetheless improved as the microwave travels within the uniform material from the waveguide to the lens in between the holes 44.

FIG. 8 shows a radar device 100 providing two microwave radiation units 110, 120 according to the invention, as particularly described in FIG. 2 to FIG. 7.

The first microwave radiation unit 110 is implemented on a first rigid part of a PCB board 70, as previously described, and the second microwave radiation unit 120 is implemented on a second rigid part of the PCB board 70. The PCB board 70 particularly is a multilayer circuit board. The first microwave radiation unit 110 and the second microwave radiation unit 120 are connected to at least one radar control unit 140 via transmission lines 116a, 116b, 126a, 126b.

The first part 110 and the second part 120 are interconnected by a connecting part 130. This connecting part 130 only comprises a first core layer where the C1-M1 and the C1-M2 metal layers are used to provide the transmission line 126a, 126b between the first and the second part of the PCB board 70. This allows a very efficient and noise reduced transmission of signals between the first and the second part. As most of the other core layers are removed the remaining C1-DL layer is sufficiently flexible to be bent to allow an angle of 90° between the two radiation units. By using the first radiation unit 110 as transmission antenna and the second radiation unit 120 as receiving antenna, where both radiation units 110, 120 are connected to at least one radar control unit 140, a highly effective high frequency 3D radar imaging device can be provided.

### LIST OF REFERENCE SIGNS

10 microwave radiation unit
12 refractive beamformer
14 transmission line
16 transition structure
18 coupling structure
20 waveguide
32 waveguide connection zone
34 beamformer connection zone
36 dielectric body of the waveguide
38 dielectric body of the refractive beamformer
40 microwave radiation unit
42 gradient index lens
50a transition structure
50b transition structure
50c transition structure
50d transition structure
50e transition structure
52a waveguide
52b waveguide
52c waveguide
52d waveguide
52e waveguide
62a transmission line
62b transmission line
62c transmission line
62d transmission line
62e transmission line
70 PCB-board
72 coupling structure
82 through vias
100 Radar device
110 microwave radiation unit
116a transmission line
116b transmission line
120 microwave radiation unit
126a transmission line
126b transmission line
130 Connecting part
140 radar control unit
A middle axis
C1 core layer
C1-M1 metallic layer
C1-DL dielectric layer
C1-M2 metallic layer
C2 core layer
C2-M1 metallic layer
C2-DL dielectric layer
C2-M2 metallic layer
C3 core layer
C3-M1 metallic layer
C3-DL dielectric layer
C3-M2 metallic layer
C4 core layer
C4-M1 metallic layer
C4-DL dielectric layer
C4-M2 metallic layer
P1 prepreg layer
P2 prepreg layer
P3 prepreg layer
T main travel direction
TP transition point

1-28. (canceled)

29: A microwave radiation unit (10, 40), comprising
a refractive beamformer (12),
a transition structure (16, 50a, 50b, 50c, 50d, 50e), wherein the transition structure (16, 50a, 50b, 50c, 50d, 50e) comprises a coupling structure (18, 72) and a waveguide (20, 52a, 52b, 52c, 52d, 52e) comprising a main travel direction (T), and
at least one transmission line (14), wherein the at least one transmission line (14) is connected to the refractive beamformer (12, 42) by the transition structure (16, 50a, 50b, 50c, 50d, 50e),
wherein the refractive beamformer (12) and the waveguide (20, 52a, 52b, 52c, 52d, 52e) each comprise parallel metallic layers (C1-M1, C4-M2) and a solid dielectric body (36, 38) between the parallel metallic layers (C1-M1, C4-M2), the solid dielectric body (36) of the waveguide (20, 52a, 52b, 52c, 52d, 52e) and the solid dielectric body (38) of the refractive beamformer (18) comprise at least one common connecting layer (L1, L2, L3, L4, C1-DL, C2-DL, C3-DL, C4-DL, P1, P2, P3) of one solid dielectric material (M1, M2, M3, M4) extending from the waveguide (20, 52a, 52b, 52c, 52d, 52e) into the refractive beamformer (18), so that the solid dielectric body (36) of the waveguide (20, 52a, 52b, 52c, 52d, 52e) and the solid dielectric body (38) of the refractive beamformer (12, 42) merge, at least partially, into each other, and
wherein the at least one common connecting layer (L1, L2, L3, L4, C1-DL, C2-DL, C3-DL, C4-DL, P1, P2, P3) extends over the whole lateral extension of the solid dielectric body (36) of the waveguide (20) and the solid dielectric body (38) of the beamformer (12).

30: The microwave radiation unit according to claim 29, wherein the at least one common connecting layer (L1, L2, L3, L4, C1-DL, C2-DL, C3-DL, C4-DL, P1, P2, P3) comprises an interconnecting region in between a functional boundary of the refractive beamformer (12) and a functional boundary of the waveguide (20).

31: The microwave radiation unit according to claim 29, wherein the extension of the common connecting layer in a direction orthogonal to the metallic layers (C1-M1, C4-M2) is of the distance between the parallel metallic layers (C1-M1, C4-M2).

32: The microwave radiation unit according to claim 29, wherein the solid dielectric body (36) of the waveguide (20) and the solid dielectric body (38) of the refractive beamformer (12) comprise a plurality of common connecting layers (L1, L2, L3, LA, C1-DL, C2-DL, C3-DL, C4-DL, P1, P2, P3) whose respective dielectric materials (M1, M2, M3, M4) can be different but have a similar permittivity.

33: The microwave radiation unit according to claim 29, wherein a distance between the refractive beamformer (12) and the waveguide (20) is smaller than 0.2 mm.

34: The microwave radiation unit according to claim 29, wherein the refractive beamformer (12) is cylindrical and of an elliptical, particularly circular, cross-section parallel to the metallic layers (C1-M1, C4-M2).

35: The microwave radiation unit according to claim 29, wherein the refractive beamformer (12) is a gradient index lens (42), particularly a generalized Luneburg lens.

36: The microwave radiation unit according to claim 35, wherein the refractive beamformer (12) is of a cylindrical shape having a middle axis (A), where the refractive beamformer (12) is of the same height as the waveguide (20), particularly about 2.2 mm—where particularly the adjacent metallic layers (C1-M1, C4-M2) of the waveguide (20; 52a, 52b, 52c, 52d, 52e) and the lens (42) are connected.

37: The microwave radiation unit according to claim 35, wherein the solid dielectric body (38) of the gradient index lens comprises at least one layer (C1-DL, C2-DL, C3-DL, C4-DL, P1, P2, P3) of a solid dielectric material, where refractive properties of the gradient index lens (42) are established by holes which are introduced into the solid dielectric body (38), where the holes are particularly filled with a fluid, more particular with air.

38: The microwave radiation unit according to claim 37, wherein the holes are introduced in a way to change the density of the solid dielectric body (38) of the gradient index lens (42) by changing the quantity and/or the diameter of the holes where the density varies, particularly increases, from an edge region to the center.

39: The microwave radiation unit according to claim 35, wherein the height of the gradient index lens (42) equals the height of the waveguide (20, 52a, 52b, 52c, 52d, 52e), where the width (w) of the waveguide (20, 52a, 52b, 52c, 52d, 52e) is set to work at a given frequency band.

40: The microwave radiation unit according to claim 29, wherein the length (L) of the waveguide (20, 52a, 52b ,52c, 52d, 52e), in main travel direction (T), corresponds to half the guided wavelength LG, and the guided wavelength is defined as the distance between two equal phase planes along the waveguide (20, 52a, 52b, 52c, 52d, 52e).

41: The microwave radiation unit according to claim 29, wherein the height (h) of the waveguide (20, 52a, 52b ,52c, 52d, 52e) is bigger than half of the guided wavelength in the solid dielectric material of the waveguide (lambda_{considering the DSM of the waveguide}/2) for a polarization perpendicular to the middle axis (A) of the cylindrical lens.

42: The microwave radiation unit according to claim 34, wherein the width (w) of the waveguide (20, 52a, 52b, 52c, 52d, 52e) is bigger than half of the guided wavelength in the solid dielectric material of the waveguide (lambda_{considering the DSM of the waveguide}/2); for a polarization parallel to the middle axis (A) of the cylindrical lens (42).

43: The microwave radiation unit according to claim 42, wherein the width (w) of the waveguide (20, 52a, 52b, 52c, 52d, 52e) is smaller than the height (h) of the waveguide (20, 52a, 52b, 52c, 52d, 52e).

44: The microwave radiation unit according to claim 29, wherein the transmission line (14), the transmission structure (16) and the refractive beamformer (12, 42) are integrally manufactured in a single solid dielectric body (36, 38).

45: The microwave radiation unit according to claim 34, wherein the coupling structure (18, 72) comprises a probe, the length of the probe within the waveguide (20; 52a, 52b, 52c, 52d, 52e) is particularly half of the height (h) of the waveguide (20; 52a, 52b, 52c, 52d, 52e) with the probe extending parallel to the middle axis (A) of the cylindrical refractive beamformer (12, 42).

46: The microwave radiation unit according to claim 45, wherein the length of the probe corresponds to half the width of the waveguide (20; 52a, 52b, 52c, 52d, 52e), and the probe extends perpendicular to the middle axis (A).

47: The microwave radiation unit according to claim 45, wherein the diameter of the probe is small compared to the guided wavelength L_{G}, ideally as small as possible.

48: The microwave radiation unit according to claim 29, wherein the at least one common connecting layer (L1, L2, L3, L4, C1-DL, C2-DL, C3-DL, C4-DL, P1, P2, P3) extends over the whole dielectric bodies (36, 38) and the metallic layers (C1-M1, C4-M2) are part of a multilayer printed circuit board (70), and the dielectric layers (L1, L2, L3, L4, C1-DL, C2-DL, C3-DL, C4-DL, P1, P2, P3) are stacked along the direction of the middle axis and comprise the dielectric body of core layers (C1, C2, C3, C4) and/or prepreg layers (P1, P2, P3).

49: The microwave radiation unit according to claim 41, wherein the probe (72) is embodied as blind via.

50: The microwave radiation unit according to claim 49, wherein the multilayer printed circuit board (70) comprises a middle metallic layer (C2-M2) that is connected to the transmission line (C1-M1; 62a, 62b, 62c, 62d, 62) by the metalized blind via (72).

51: The microwave radiation unit according to claim 49, wherein the multilayer circuit board (70) is stacked in a way that the middle metallic layer (C2-M2) to which the blind via extends, lies at a distance from the outermost parallel metallic layers (C1-M1, C4-M2) that is approximately half the height (h) of the waveguide (52a, 52b, 52c, 52d, 52e).

52: The microwave radiation unit according to claim 49, wherein the multilayer circuit board (70) providing the transmission line (62a, 62b, 62c, 62d, 62e), comprises a metal trace (C1-M1) on top of the dielectric body (C1-DL) and a ground layer (C1-M2) below the dielectric material of the uppermost layer opposite to the metal trace to confine the electric field in the direction parallel to the cylinder axis (A), and the ground layer (C1-M2) is constructed in a way that it is not conductively connected to the blind via (72).

53: The microwave radiation unit according to claim 47, wherein sidewalls of the waveguide (52a, 52b, 52c, 52d, 52e) are embodied as through vias (82) having an adjacent distance that is small compared to the guided wavelength (L_{G}), preferably below 0.8 mm, more preferably below 0.4 mm.

54: A printed circuit board transceiver (100) comprising
a multilayer circuit board (70), and
at least one microwave radiation unit (110, 120) according to claim 29,
wherein the dielectric body of the waveguide and the dielectric body of the refractive beamformer is formed by layers of the multilayer circuit board (70),
the at least one transmission line (116a, 116b, 126a, 126b) is connected to at least one integrated circuit (140) to feed signals to the radiation unit (110, 120) and/or receive signals from the radiation unit (110, 120), and
the integrated circuit (140) is mounted on the multilayer circuit board (70) preferably on the layer where the transmission line is accessible, more preferably on the top or the bottom layer.

55: The printed circuit board according to claim 54, wherein it comprises at least two microwave radiation units (110, 120), the at least two microwave radiation units (110, 120) are connected to the at least one integrated circuit (140), and the integrated circuit (140) particularly is a radar circuit.

56: The printed circuit board according to claim 55, wherein the multilayer circuit board (70) comprises a connecting part (130) connecting the at least two microwave radiation units (110, 120), the connecting part (130) comprises at least three layers (C1-M1; C1-DL, C1-M2), and two layers are necessary to implement the transmission line on the connecting part.
